(19) United States
(12) Patent Application Publication
(10) Pub. No.: US 2020/0089801 A1
(43) Pub. Date: Mar. 19, 2020

(54) DISTURBANCE-FREE PARTITIONING AND MIGRATION OF DATA FROM ONE STORAGE ACCOUNT TO ANOTHER STORAGE ACCOUNT

(71) Applicant: Microsoft Technology Licensing, LLC, Redmond, WA (US)

(72) Inventors: Parveen Kumar Patel, Cupertino, CA (US); Kamel Sbaia, San Jose, CA (US); Mohit Garg, Redmond, WA (US); Abhishek Agarwal, Bellevue, WA (US); Bikash Kumar Agrawala, Cupertino, CA (US); Abhishek Kumar Tiwari, Redmond, WA (US)

(21) Appl. No.: 16/135,693

(22) Filed: Sep. 19, 2018

(51) Int. Cl. G06F 17/30; H04L 29/08

(52) U.S. Cl. CPC G06F 17/30575; H04L 67/325; G06F 17/30315; G06F 17/30362

(57) ABSTRACT

Methods and devices for data migration may include initially processing requests from a plurality of geographic regions for a cloud service using a global back-end service with a global storage account storing data. The methods and devices may include establishing a region back-end service with a region storage account in at least one geographic region of the plurality of geographic regions to support the cloud service for users in the at least one geographic region, wherein the region back-end service includes a region RTable. The methods and devices may include receiving, by the region back-end service, user requests for the cloud service from one or more users in the at least one geographic region and accessing, via the region RTable, one or more rows of data associated with the at least one geographic region from the global storage account in response to the user requests.

### BACKGROUND

The present disclosure relates to data migration and remote data storage.

When a global cloud service keeps the data for the service in one global storage account, both the service and the storage account are a single point of failure. In the event of a storage outage and/or a natural disaster in the region of the global storage account, customers in all geographic regions will be impacted. For example, customers in different geographic regions where the outage occurred may not be able to access their data and/or continue using the services until access to the global storage account is restored. As such, the global storage account is a single point of failure for the customer's data.

Thus, there is a need in the art for improvements in remote data storage.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

One example implementation relates to a computer device. The computer device may include a memory to store data and instructions, a processor in communication with the memory, an operating system in communication with the memory and the processor, the operating system operable to: initially process requests from a plurality of geographic regions for a cloud service using a global back-end service with a global storage account storing data from a plurality of geographic regions, wherein the global back-end service includes a global replicated table (“RTable”); establish a region back-end service with a region storage account in at least one geographic region of the plurality of geographic regions to support the cloud service for users in the at least one geographic region, wherein the region back-end service includes a region RTable; receive, by the region back-end service, user requests for the cloud service from one or more users in the at least one geographic region; access, via the region RTable, one or more rows of data associated with the at least one geographic region from the global storage account in response to the user requests; lock, by the global RTable, the one or more rows of data associated with the at least one geographic region in the global storage account during replication of the one or more rows of data in response to the access; replicate the one or more rows of data accessed by the region RTable into the region storage account; and update a configuration to inactivate the one or more rows of data associated with the at least one geographic region in the global storage account in response to a conclusion of the access to the one or more rows of data associated with the at least one geographic region by the region RTable in response to the user requests.

Another example implementation relates to a method for data migration. The method may include initially processing, by an operating system executing on a computer device, requests from a plurality of geographic regions for a cloud service using a global back-end service with a global storage account storing data from a plurality of geographic regions, wherein the global back-end service includes a global replicated table (“RTable”). The method may include establishing a region back-end service with a region storage account in at least one geographic region of the plurality of geographic regions to support the cloud service for users in the at least one geographic region, wherein the region back-end service includes a region RTable. The method may include receiving, by the region back-end service, user requests for the cloud service from one or more users in the at least one geographic region. The method may include accessing, via the region RTable, one or more rows of data associated with the at least one geographic region from the global storage account in response to the user requests. The method may include locking, by the global RTable, the one or more rows of data associated with the at least one geographic region in the global storage account during replication of the one or more rows of data in response to the access. The method may include replicating the one or more rows of data accessed by the region RTable into the region storage account. The method may include updating a configuration to inactivate the one or more rows of data associated with the at least one geographic region in the global storage account in response to a conclusion of the access to the one or more rows of data associated with the at least one geographic region by the region RTable in response to the user requests.

Another example implementation relates to computer-readable medium storing instructions executable by a computer device. The computer-readable medium may include at least one instruction for causing the computer device to initially process requests from a plurality of geographic regions for a cloud service using a global back-end service with a global storage account storing data from a plurality of geographic regions, wherein the global back-end service includes a global replicated table (“RTable”). The computer-readable medium may include at least one instruction for causing the computer device to establish a region back-end service with a region storage account in at least one geographic region of the plurality of geographic regions to support the cloud service for users in the at least one geographic region, wherein the region back-end service includes a region RTable. The computer-readable medium may include at least one instruction for causing the computer device to receive, by the region back-end service, user requests for the cloud service from one or more users in the at least one geographic region. The computer-readable medium may include at least one instruction for causing the computer device to access, via the region RTable, one or more rows of data associated with the at least one geographic region from the global storage account in response to the user requests. The computer-readable medium may include at least one instruction for causing the computer device to lock, by the global RTable, the one or more rows of data associated with the at least one geographic region in the global storage account during replication of the one or more rows of data in response to the access. The computer-readable medium may include at least one instruction for causing the computer device to replicate the one or more rows of data accessed by the region RTable into the region storage account. The computer-readable medium may include at least one instruction for causing the computer device to update a configuration to inactivate the one or more rows of data associated with the at least one geographic region in the global storage account in response to a conclusion of the access to the one or more rows of data associated with the at least one geographic region by the region RTable in response to the user requests.

Additional advantages and novel features relating to implementations of the present disclosure will be set forth in part in the description that follows, and in part will become more apparent to those skilled in the art upon examination of the following or upon learning by practice thereof.

### DESCRIPTION OF THE FIGURES

In the drawings:

FIG. 1 is a schematic block diagram of an example system for use with global services in accordance with an implementation of the present disclosure;

FIG. 2 is a schematic block diagram of an example method flow for data migration in accordance with an implementation of the present disclosure;

FIG. 3 is a schematic block diagram of an example method flow for using a replicated table to replicate data in accordance with an implementation of the present disclosure;

FIGS. 4A-4C are schematic block diagrams of an example method flow for establishing a new region back-end service in accordance with an implementation of the present disclosure; and

FIG. 5 is a schematic block diagram of an example device in accordance with an implementation of the present disclosure.

### DETAILED DESCRIPTION

This disclosure relates to devices and methods for partitioning and migrating data from a global storage account associated with a global service, such as a cloud service, to a regional storage account with zero down-time to the business and/or the data. When a cloud service system uses a global back-end service to support the cloud services, a global storage account may be used to store all customers' data, regardless of the customer's geographic location. In the event of a storage outage and/or a natural disaster in the geographic region of the global storage account, customers in all geographic regions may be impacted. As such, the global storage account may provide a single point of failure for all customers' data, including those customers outside of the geographic region where the storage outage and/or natural disaster occurred.

As the global service grows and/or more data is received from customers, establishing region specific back-end services to provide support and/or data storage for customers in a specific geographic region may reduce a blast radius of a data outage and/or the cascading effects of the storage outage. For example, if a data outage occurred in one geographic region (e.g., Europe), for example, due to a natural disaster in the geographic region, the disruptions to data access may be limited to the geographic region where the data outage occurred, while data in other geographic regions (e.g., Asia and Australia) may not be effected by the data outage. As such, customers in other regions may continue to use the global services.

The devices and methods may establish a region back-end service to process requests to the global service received from the geographic region of the region back-end service, while contemporaneously operating the global service in a manner so that down-time is avoided. In addition, the region specific back-end services may provide a region storage account for storing customer data in the specific region. Moreover, regarding the contemporaneous operation, the devices and methods may seamlessly migrate data from the global storage account to the region storage account using a replication service for data tables. Replication services for data tables, such as, a Replicated Table (“RTable”), may be used to replicate the data from the global storage account to the region storage account without interruptions to the customer experience. For example, the replication services may ensure that the data being replicated and/or copied from the global storage account to the region storage account is not stale and may account for any recent changes and/or modifications to the data. During the establishment of the region back-end service, the methods and devices may route or transition region related traffic and/or requests from the global service to the new regional service with zero down-time and/or disturbance to the customers of the service.

The amount of data being transferred from the global storage account to the region storage account may be extremely large, and the data is constantly changing, which makes a zero-down-time, seamless establishment and transition to the region back-end service incredibly challenging. For example, the data may range in size of terabytes. In addition, the distance between the global storage account and the region storage account may be significant. For example, the data may be moving from the U.S. to Australia. As such, the transfer of the data from the global storage account to the region storage account may take several weeks to accomplish. Additionally, during the transfer time period, all or portions of the data may be continuously changing due to ongoing user requests and updates. The devices and methods can overcome these tremendous challenges by providing procedures to ensure that the transferred data is current and not stale.

In addition, the transfer of the data may occur in a controlled environment so that a verification of the data in the region storage account may occur to ensure that the region storage account is stable prior to disconnecting the region specific back-end services from the global back-end services. Upon completing the verification of the data in the region storage account, the devices and methods may remove connections from the region specific back-end services to the global back-end services and operate independently from the back-end services.

By establishing region specific back-end services to provide support and/or data storage for customers in a specific region, a blast radius of a data outage may be reduced and the cascading effects of the storage outage may be minimized. As such, customers in different geographical regions than where a data outage occurred may not experience an interruption in using the cloud services.

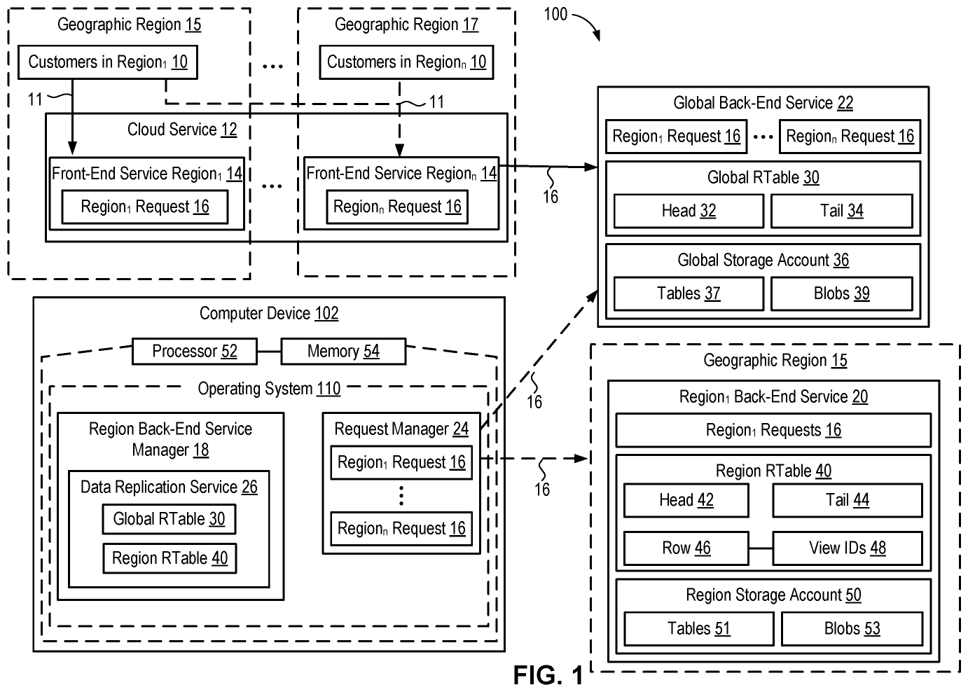

Referring now to FIG. 1, an example system 100 for providing global services, such as cloud services 12, to one or more users, such as customers 10 in different geographical regions (up to n geographical regions, where n is an integer) may include a plurality of front-end services 14 in a plurality of geographic regions where customers 10 may send API requests 11 for the cloud service 12. For example, when the cloud service 12 is new and/or just starting, a single global back-end service 22 with a global storage account 36 may support the cloud service 12. Cloud services 12 may include, but are not limited to, storage services for storing and accessing data on the cloud and/or online services, such as, editing documents, sending email, streaming audio and video, and hosting websites.

As such, customers 10 in a region may make one or more application programming interface (API) requests 11 to the front-end services 14 in the same region and/or a different region as the customers 10. The front-end services 14 may act as proxies by transforming the requests 11 into region requests 16 associated with a particular geographic regions 15 and/or 17, and forwarding the region requests 16 to the global back-end service 22 for actual processing. The global back-end service 22 may maintain its state in a global storage account 36 with tables 37 and/or blobs 39 for storing the customer's 10 data. For example, blobs 39 may store unstructured data from a customer 10. As such, regardless of the customer's 10 physical location, the global back-end service 22 may process the API requests 11 received from the customers 10.

When a cloud service 12 keeps all its state in one global storage account 36, the global back-end service 22 may be a single point of failure for the cloud service 12. For example, if a data outage and/or a natural disaster occurred in the geographic region of the global storage account 36, a global outage may occur for the cloud service 12. Thus, customers 10 in different geographic regions where the data outage and/or natural disaster occurred may be unable to use the cloud service 12.

In order to limit a blast radius of an outage, computer device 102 may include a region back-end service manager 18 operable to regionalize the cloud service 12 by establishing one or more region back-end services 20 up to m (where m is an integer) to handle region related traffic requests for the cloud service 12. For example, region back-end service 20 may be established in geographic region 15 to handle geographic region 15 related traffic requests for the cloud service 12. Geographic region 15 related traffic requests may include, but are not limited to, requests for resources associated with geographic region 15, requests from customer accounts associated with geographic region 15, and/or requests from devices physically located within geographic region 15. Region back-end service 20 may include a region storage account 50 for storing geographic region 15 related data. In addition, region back-end service 20 may include a region RTable 40 for replicating data associated with geographic region 15 from the global storage account 36 into the regional storage account 50.

Computer device 102 computer device 102 may be located anywhere (e.g., on its own, in the front-end service region 14, in the global back-end service 22, and/or in the region back-end service 20. In addition, computer device 102 may communicate with each of the front-end service regions 14, the global back-end service 22, and/or the one or more region back-end services 20.

A request manager 24 may receive the region requests 16 from the front-end services 14 and may determine whether to transmit the region requests 16 to the global back-end service 22 and/or the region back-end service 20 for processing. For example, if the region requests 16 is for a resource associated with geographic region 15, (e.g., the geographic region of the region back-end service 20), request manager 24 may transmit the region request 16 to the region back-end service 20 for processing. If the region request 16 is for a resource associated with other geographic regions than geographic region 15, request manager 24 may transmit the region request 16 to the global back-end service 22 for processing. As such, request manager 24 may monitor region requests 16 to ensure they may be routed to the proper back-end service for processing.

Computer device 102 may include an operating system 110 executed by processor 52 and/or memory 54. Memory 54 of computer device 102 may be configured for storing data and/or computer-executable instructions defining and/or associated with operating system 110, and processor 52 may execute such data and/or instructions to instantiate operating system 110. An example of memory 54 can include, but is not limited to, a type of memory usable by a computer, such as random access memory (RAM), read only memory (ROM), tapes, magnetic discs, optical discs, volatile memory, non-volatile memory, and any combination thereof. An example of processor 52 can include, but is not limited to, any processor specially programmed as described herein, including a controller, microcontroller, application specific integrated circuit (ASIC), field programmable gate array (FPGA), system on chip (SoC), or other programmable logic or state machine.

Computer device 102 may include any mobile or fixed computer device, which may be connectable to a network. Computer device 102 may be, for example, a computer device such as a desktop or laptop or tablet computer, a cellular telephone, a gaming device, a mixed reality or virtual reality device, a music device, a television, a navigation system, a camera, a personal digital assistant (PDA), or a handheld device, or any other computer device having wired and/or wireless connection capability with one or more other devices and/or communication networks.

Operating system 110 may include the region back-end service manager 18 that partitions and/or migrates the data from the global storage account 36 to the newly established region storage account 50 for the region back-end service 20 with zero down-time to the cloud service 12.

The region back-end service manager 18 may include a data replication service 26 that identifies which data to copy from the global storage account 36 to the region storage account 50. Data replication service 26 may determine whether the data is associated with geographic region 15 of the region back-end service 20. Data replication service 26 may identify whether the data is associated with one or more customers 10 from geographic region 15 and/or whether the region request 16 associated with the data originated from geographic region 15. For example, a determination may be made by data replication service 26 based on customer account data, based on information associated with customer requests that may identify or be associated with a particular geographic region, based on a geographic location associated with a customer profile, based on a geographic location associated with an address of a device used to initiate the user request (e.g., an internet protocol (IP) address of the computer), based on a geographic region associated with a requested resource, etc. Data that is associated with geographic region 15 of the region back-end service 20 may be identified as data to copy to the region storage account 50. Data that is not associated with geographic region 15 may remain in the global storage account 36 and may not be copied to the region storage account 50.

In addition, data replication service 26 may ensure that the data is in a state that can be migrated to the region storage account 50. For example, data replication service 26 may verify that the data is not shared among different geographic regions. Data replication service 26 may also verify that the data is not currently being accessed by a customer 10. As such, data replication service 26 may identify which data to copy from the global storage account 36 to the region storage account 50.

Data replication service 26 may replicate and/or copy the identified data from the global storage account 36 to the region storage account 50. In an implementation, the data replication service 26 may create a global replicated table (“RTable”) 30 with a head 32 and a tail 34 that provides synchronous geo-replication capability of the data stored in the global storage account 36.

In addition, the data replication service 26 may create a region RTable 40 with a head 42 and a tail 44. The region RTable 40 may be used to access the tables 37 in the global storage account 36 to create a replicate of the identified data for the region. The data replication service 26 may read the data to be copied from the tail 34 of the global RTable 30 and copy the data to the head 42 of the region RTable 40. As such, the region RTable 40 may begin to be populated with the data copied from the global RTable 30. As data is copied to the region RTable 40, each row 46 of data may be associated with a view identification (ID) 48 which may indicate a status of the data (e.g., whether changes may be occurring to the data).

In an implementation, the data replication service 26 may replicate and/or copy the data that is currently being accessed by customers 10 first to the region storage account 50. Data replication service 26 may subsequently replicate and/or copy the remaining other data associated with the region until all of the data associated with the region is copied to the region storage account 50.

Upon the completion of replicating all of the data associated with the region to the region storage account 50, the region back-end service manager 18 may disconnect the region back-end service 20 from the global back-end service 22. As such, the region back-end service 20 may operate independently from the global back-end service 22 in handling region requests 16 for customers 10 within the geographic region of the region back-end service 20, while the global back-end service 22 or other regional back-end services may handle other customers 10 requests for the cloud service 12.

By establishing region specific back-end services to provide support and/or data storage for customers in a specific region, a blast radius of a data outage may be reduced and the cascading effects of the storage outage may be minimized.

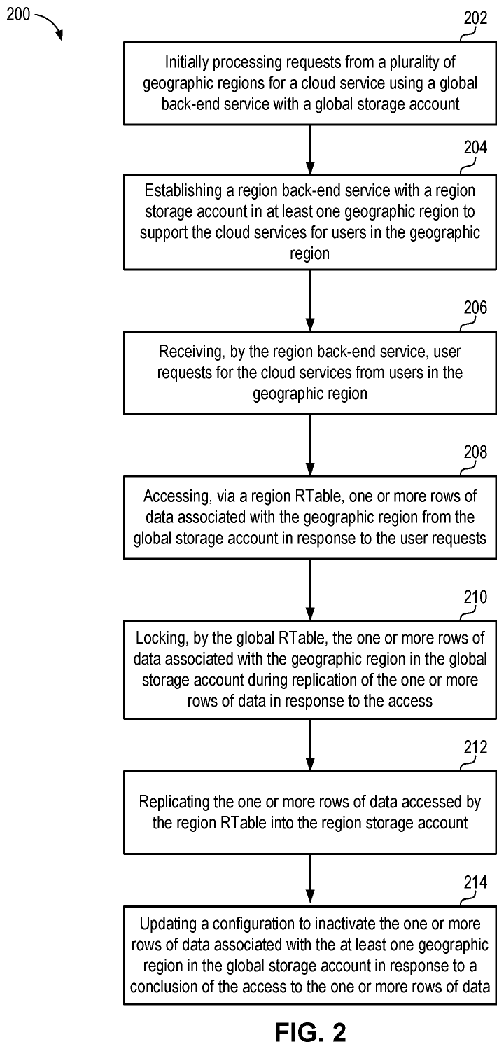

Referring now to FIG. 2, a method flow 200 for data migration for use with cloud services 12 (FIG. 1) by computer device 102 (FIG. 1) is discussed in connection with the description of the architecture of FIG. 1.

At 202, method 200 may include initially processing requests from a plurality of geographic regions for a cloud service using a global back-end service with a global storage account. Global storage account 36 may store data from a plurality of geographic regions (e.g., geographic region 15 and geographic region 17). In addition, global back-end service 22 may include a global RTable 30 for replicating the data stored in global storage account 36. For example, a global service, such as a cloud service 12, may include a plurality of front-end services 14 in a plurality of geographic regions (e.g., geographic region 15 and geographic region 17) where one or more users, such as customers 10, may send API requests 11 for the cloud service 12. Each of the front-end services 14 may have processors and may parse the API requests 11 to determine what the API request 11 is about and may transmit one or more region requests 16 based on the determination. A single global back-end service 22 with a global storage account 36 may support the cloud service 12.

As such, customers 10 in a region may make one or more application programming interface (API) requests 11 to the front-end services 14 in the same region and/or a different region as the customers 10. For example, customers in geographic region 15 may make API requests 11 to the front-end services 14 in geographic region 15 and/or geographic region 17. The front-end services 14 may act as proxies by transforming the requests 11 into region requests 16 associated with a particular geographic regions 15 and/or 17, and forwarding the region requests 16 to the global back-end service 22 for actual processing. The global back-end service 22 may maintain its state in a global storage account 36 with tables 37 and/or blobs 39 for storing the customer's 10 data. As such, regardless of the customer's 10 physical location and/or location associated with the customer's account, the global back-end service 22 may process the API requests 11 received from the customers 10.

At 204, method 200 may include establishing a region back-end service with a region storage account in at least one geographic region to support the cloud services for users in the geographic region. A region back-end service manager 18 may regionalize the cloud service 12 by establishing one or more region back-end services 20 up to m (where m is an integer) to handle region related traffic requests for the cloud service 12. For example, region back-end service 20 may be established in geographic region 15 to handle geographic region 15 related traffic requests for the cloud service 12. Geographic region 15 related traffic requests may include, but are not limited to, request for resources associated with geographic region 15, requests from customer accounts associated with geographic region 15, and/or requests from devices physically located within geographic region 15. Region back-end service 20 may include a region storage account 50 for storing geographic region 15 related data. In addition, region back-end service 20 may include a region RTable 40 for replicating data associated with geographic region 15 from the global storage account 36 into the regional storage account 50. For example, a computer in the region may be setup in the region to process and/or store the data.

At 206, method 200 may include receiving, by the region back-end service, user requests for cloud services from users in the geographic region. A request manager 24 may receive the region requests 16 from the front-end services 14 and may determine whether to transmit the region requests 16 to the region back-end service 20 and/or the global back-end service 22 for processing. For example, region requests 16 for resources associated with geographic region 15 may be transmitted to the region back-end service 20 for processing. In addition, region requests 16 from customers physically located in geographic region 15 and/or from customer accounts associated with geographic region 15 may be transmitted to the region back-end service 20 for processing. For example, front-end service regions 14 may be configured to start sending region requests 16 to the region back-end service 20 in the region. However, if the region request 16 is for resources associated with other geographic regions than geographic region 15, request manager 24 may transmit the region request 16 to the global back-end service 22 for processing. For example, front-end service regions 14 may be configured to send region requests 16 to the global back-end service 22 for processing. As such, request manager 24 may monitor region requests 16 to ensure they may be routed to the proper back-end service for processing.

In an implementation, requests manager 24 may monitor the processing time of the region requests 16. For example, a predetermined allotted time for the processing of region requests 16 may be set. If the region requests 16 are not completed by the predetermined allotted time, the processing may be aborted and the region requests 16 may be marked as timed-out. Thus, region requests 16 may be time-bounded and may not run forever.

At 208, method 200 may include accessing, via a region RTable, the one or more rows of data associated with the geographic region from the global storage account in response to the user requests. The region back-end service manager 18 may include a data replication service 26 that identifies which one or more rows of data to copy from the global storage account 36 to the region storage account 50. Data replication service 26 may determine whether the data is associated with geographic region 15 of the region back-end service 20 and/or whether the region request 16 is associated with data originated from other geographic regions (e.g., geographic region 17). For example, the determination may be based on customer account data, based on information associated with customer requests that may identify or be associated with a particular geographic region, based on a geographic location associated with a customer profile, based on a geographic location associated with an address of a device used to initiate the user request (e.g., an internet protocol (IP) address of the computer), based on a geographic region associated with a requested resource, etc. Data that is associated with geographic region 15 of the region back-end service 20 may be identified as data to copy to the region storage account 50. Data that is not associated with the geographic region (e.g., associated with geographic region 17) may remain in the global storage account 36 and may not be copied to the region storage account 50.

In addition, data replication service 26 may ensure that the data is in a state that can be migrated to the region storage account 50. For example, data replication service 26 may verify that the data is not shared among different geographic regions. Data replication service 26 may also verify that the data is not currently being accessed by a customer 10. For example, data replication service 26 may verify that the one or more rows of data are not locked. As such, data replication service 26 may identify which one or more rows of data to copy from the global storage account 36 to the region storage account 50.

In an implementation, the data replication service 26 may create a global replicated table (“RTable”) 30 with a head 32 and a tail 34 that provides synchronous geo-replication capability of the data stored in the global storage account 36. In addition, the data replication service 26 may create a region RTable 40 with a head 42 and a tail 44. The region RTable 40 may be used to access the data tables 37 in the global storage account 36 to create a replicate of the identified data for the region.

At 210, method 200 may include locking, by the global RTable, the one or more rows of data associated with the geographic region in the global storage account during replication of the one or more rows of data in response to the access. Data replication service 26 may lock the one or more rows of data in the global storage account 36 during the replication of the one or more rows of data, and thus, preventing other access of the one or more rows of data during the replication process. As such, the system may contemporaneously support on-going user requests at the region back-end service 20 while transferring data to the region storage account 50.

At 212, method 200 may include replicating the one or more rows of data accessed by the region RTable into the region storage account. Data replication service 26 is configured to replicate the identified one or more rows of data from the global storage account 36 to the region storage account 50. For example, the region RTable 40 may read the one or more rows of the data to be copied from the tail 34 of the global RTable 30 and copy the data to the head 42 of the region RTable 40. As such, the region storage account 50 may begin to be populated with the data copied from the global RTable 30 using the region RTable 40.

In an implementation, the data replication service 26 may replicate and/or copy the data that is currently being accessed by customers 10 first to the region storage account 50. Data replication service 26 may subsequently replicate and/or copy the remaining other data associated with the region until all of the data associated with the region is copied to the region storage account 50. In another implementation, the data replication service 26 may replicate and/or copy the data that is not currently being accessed by customers 10 concurrently while handling user requests for the cloud services 12.

At 214, method 200 may include updating a configuration to inactivate the one or more rows of data associated with the at least one geographic region in the global storage account in response to a conclusion of the access to the one or more rows of data. In an implementation, the configuration may be a view identification (ID) 48 associated with the one or more rows of data. Each row of data 46 may be associated with a view ID 48, which may indicate a status and/or version of the data (e.g., whether the data has been copied and/or whether any updates may have occurred to the data). As data is copied to the region RTable 40, the view IDs 48 may be updated. The view IDs 48 may be used to inactivate the one or more rows of data in the global storage account 36 to prevent the one or more rows of data from being accessed in the global storage account 36 after the one or more rows of data are replicated to the region storage account 50.

Upon the completion of replicating all of the data associated with the geographic region 15 to the region storage account 50, the region back-end service manager 18 may disconnect the region back-end service 20 from the global back-end service 22. As such, the region back-end service 20 may operate independently from the global back-end service 22 in handling region requests 16 for customers 10 within the geographic region of the region back-end service 20, while the global back-end service 22 or other region back-end services may handle requests from other customers 10 in other regions for the cloud service 12.

Thus, method 200 may migrate data from a global storage account 36 associated with a global service, such as a cloud service, to a regional storage account 50 with zero down-time to the business and/or the data.

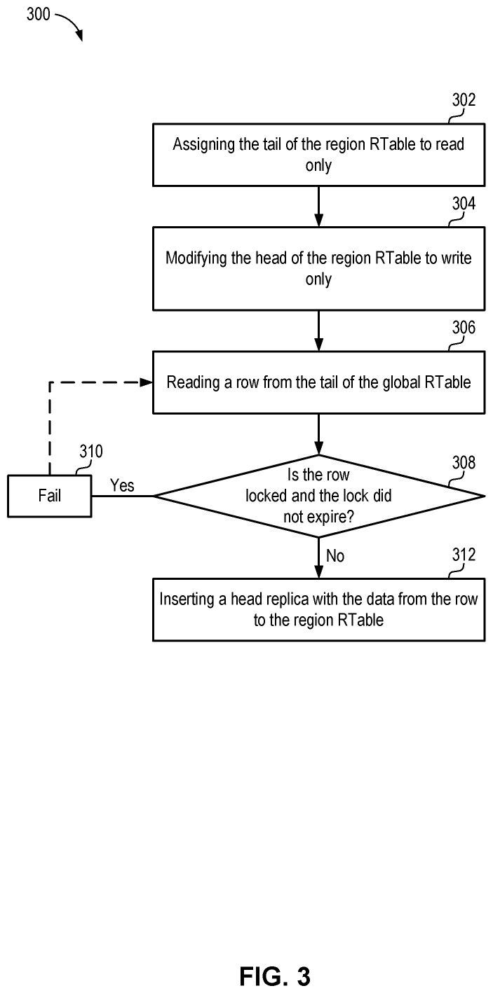

Referring now to FIG. 3, a method 300 for replicating data using a replicated table (“RTable”) for use with step 210 of method 200 (FIG. 2) by data replication service 26 (FIG. 1) by computer device 102 (FIG. 1) is discussed in connection with the description of the architecture of FIG. 1. Generally, RTables may replicate data across all regions. For example, when any write operation occurs to an RTable, the row of the data table is locked down until data is written in all RTables at the tail across the different regions. As such, data may be replicated across various regions and reads may occur from any RTable in the system and access the same data system wide.

At 302, method 300 may include assigning the tail of the replica table to read only. For example, data replication service 26 may assign the tail 44 of the region RTable 40 to read only. Typically, reads occur from the tail (e.g., bottom) of the RTable. However, when region RTable 40 is initially created, region RTable 40 is empty without any data populated in region RTable 40. As such, data replication service 26 may want to prevent reads from occurring from the tail 44 until data starts populating in region RTable 40.

At 304, method 300 may include modifying the head of the region RTable 40 to write only. Data replication service 26 may modify the head of the region RTable 40 to write only so that when new data is added to region RTable 40, the new data is added to the head of region RTable 40. In addition, data replication service 26 may modify the tail 44 of the region RTable 40 to read and write now that the data may be added to the region RTable 40. For example, the configuration of the region RTable 40 may be [Head^{WriteOnly}, Tail^{ReadWrite}].

At 306, method 300 may include reading a row from the tail of the global RTable. For example, data replication service 26 may read a row of data from the tail 34 of the global RTable 30. Data replication service 26 may determine whether the data may be identified as data to copy to the region storage account 50. If the data is identified as data to copy to the region storage account 50 (e.g., the data is associated with the geographic region of the region storage account 50), data replication service 26 may read the row of data from the tail 34 of the global RTable 30.

At 308, method 300 may include determining whether the row is locked and whether the lock has expired. Data replication service 26 may determine whether the row of data from the tail 34 of the global RTable 30 is locked. If the row is locked, the data may be changing and the read operation may be prevented.

At 310, method 300 may include determining that the read operation of the row failed. When data replication service 26 determines that the row from the tail 34 of the global RTable 30 is locked, the data may be changing. As such, data replication service 26 may determine that the read operation of the row has failed and may attempt to read the same row and/or another row from the tail 34 of the global RTable 30 (306). By verifying whether the row is locked and performing the read operation another time, down-time may be reduced by continuing the read processing.

At 312, method 300 may include inserting a head replica with the data from the row to the region RTable. When data replication service 26 determines that the row from the tail 34 of the global RTable 30 is not locked, data replication service 26 may copy the data from the row and insert the data to the head 42 of the region RTable 40. As such, data may start populating in the region RTable 40 by being added to the head 42 of the region RTable 40.

In an implementation, RTable clients (e.g., 100 to 200 different computer devices) for the region RTable 40 may refresh their view IDs 48 at different paces. For example, the RTable clients may process the data from the global RTable 30 at different rates. As such, an RTable client moving at a slower pace may have stale data if the data recently changed. For example, an RTable client may have a view ID 48 of “1” for a row 46 of data and may try to read and/or update the row 46 of data, which now may have a view ID 48 of “2.” Data replication service 26 may determine that the view IDs 48 of the rows do not match and may determine that the read and/or update has failed. Data replication service 26 may reread the row of data from the tail 34 of the global RTable 30 to ensure that the data is current in the RTable client for the region RTable 40.

By copying the data from the tail 34 of the global RTable 30 the region RTable 40 may be populated with all of the data associated with the geographic region for the region RTable 40 and the data tables may be replicated between the global RTable 30 and the region RTable 40. Moreover, by accounting for the changing data, data replication service 26 may ensure that the current data is copied to the region RTable 40 instead of stale data. As such, the region storage account 50 may support the region requests 16 received from customers 10 in the geographic region of the region back-end service 20 independently from the global back-end service 22.

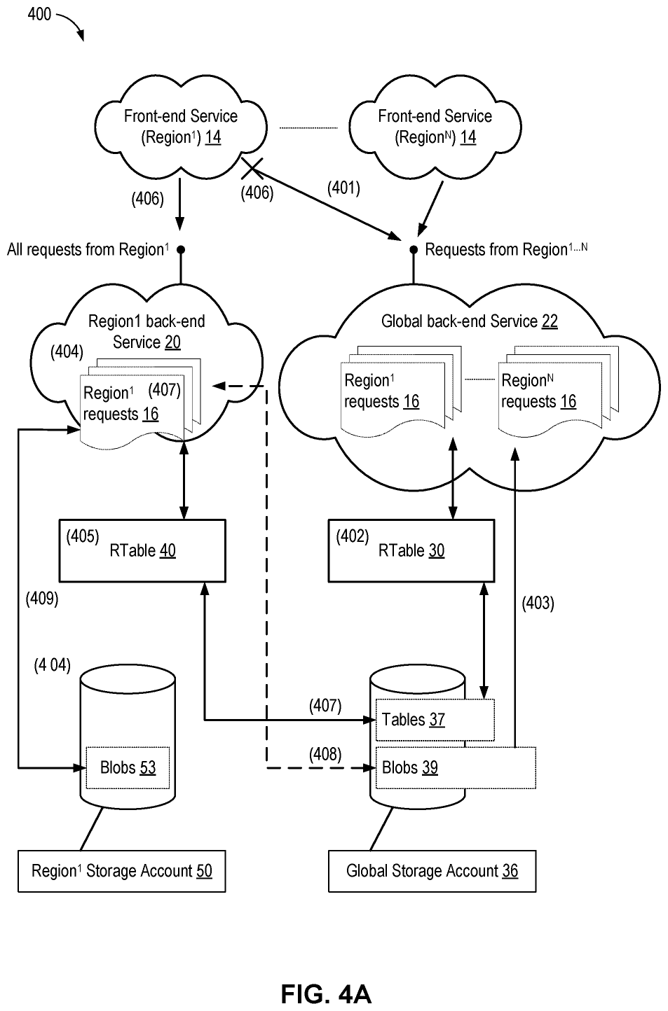

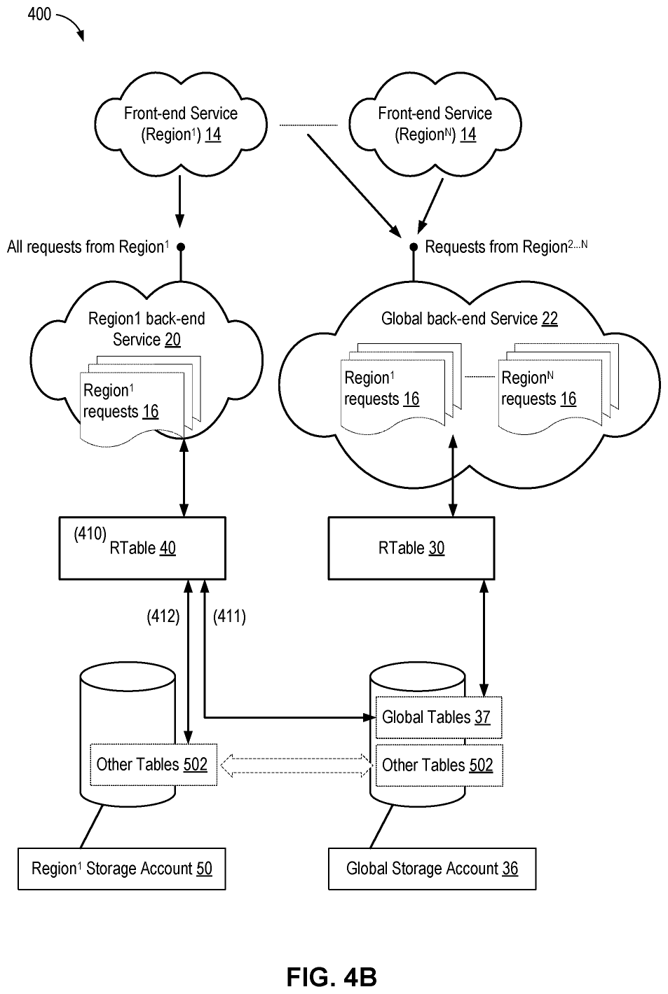

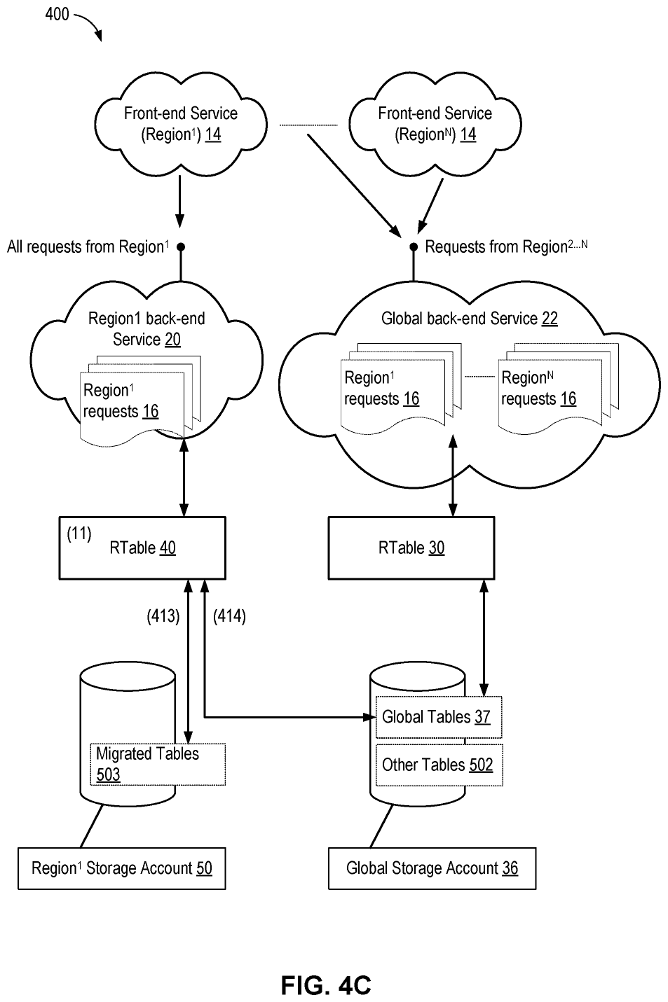

Referring now to FIGS. 4A-4C, a method 400 for establishing a new region back-end service 20 (FIG. 1) for use with cloud services 12 (FIG. 1) by computer device 102 (FIG. 1) is discussed in connection with the description of the architecture of FIG. 1. For example, FIG. 4A illustrates a new region back-end service 20 being established, FIG. 4B illustrates replicating tables between the global storage account 36 and the region storage account 50, and FIG. 4C illustrates the separation of the region back-end service 20 and the global back-end service 22. As such, method 400 may be used to establish a new region back-end service 20 to take over traffic from the global service 22 seamlessly without any down-time and/or disturbances to on-going customer requests for the cloud services 12.

Initially, at 401, requests from all regions for cloud services 12, including request from Region 1, are received and processed by the global back-end service 22. For example, global service, such as a cloud service 12, may include a plurality of front-end services 14 in a plurality of geographic regions where customers 10 may send API requests 11 for the cloud service 12. The front-end services 14 may act as proxies by forwarding region requests 16 to the global back-end service 22 for actual processing. As such, the global back-end service 22 may handle all region requests 16 for the cloud services 12.

At 402, method 400 may configuring a replica of the global storage account 36 by using global RTable 30 to access all tables 37 in the global storage account 36 of the global back-end service 22. The tail 34 of the global RTable 30 may be set to read and write and may read the data from the tables 37 of the global storage account 36. For example, the configuration of the global RTable 30 may be [Tail^{ReadWrite}=Global Storage Account]. A data replication service 26 (FIG. 1) may establish the global RTable 30 and may configure the global RTable 30.

At 403, method 400 may reference the temporary created blobs 39 in the global storage account 36 using a shared access signature (SAS) uniform resource locator (URL)s instead of URLs. As such temporary credentials (e.g., temporary passcodes) that may be time bound may provide shared access to blobs 39 for accessing and/or processing the data. For example, data replication service 26 may provide the SAS URLs.

At 404, method 400 may include deploying a new region back-end service 20 for geographic Region 1 with a region storage account 50. Geographic Region 1 may be any geographic region. For example, geographic Region 1 may be another continent and/or another country. The region back-end service 20 may run the same version of code as the global back-end service 22. At this point, the region back-end service 20 may not receive any data traffic from customers 10 for cloud service 12. For example, a region back-end service manager 18 (FIG. 1) may establish the new region back-end service 20.

At 405, method 400 may include using a region RTable 40 in region back-end service 20 to access all tables in the global storage account 36. For example, data replication service 26 may use the RTable 40 to access the tables in the global storage account 36. The region RTable 40 may be configured with one replica, for example, the tail 44 of region RTable 40 may be set as read and write to read the data from global storage account 36. For example, the configuration of the region RTable 40 may be [Tail^{ReadWrite}=Global Storage Account]. Thus, while the region RTable 40 and the global RTable 30 may have two independent configuration files, initially, region RTable 40 and global RTable 30 may have the same content.

At 406, method 400 may include configuring the front-end service 14 in Region 1 to start sending all customer requests received to the region back-end service 20 in Region 1. For example, a request manager 24 (FIG. 1) may receive the region requests 16 from the front-end services 14 and may determine whether to transmit the region requests 16 to the global back-end service 22 and/or the region back-end service 20 for processing.

At 407, method 400 may start processing Region 1 related region requests 16 using the region back-end service 20 by sharing the Global storage account 36, via region RTable 40, with the global back-end service 22.

The global back-end service 22 may process the region requests 16 within an allotted time to complete the region requests 16. If the allotted time is exceeded, the processing may be aborted and the requests is marked as timed-out. Once a region request 16 is completed and/or timed-out, the region request 16 will not be processed again. In other words, processing of region requests 16 is bounded and are unable to run forever.

At 408, method 400 may include region back-end service 20 taking over processing of an old region request 16 that was received and started by global back-end service 22, but not yet completed by the global back-end service 22. Region back-end service 20 may access the temporary created blobs 39 in the Global Storage Account 36 via SAS URLs. Such dependency on the Global Storage Account may be temporary (e.g., until the last old region request 16 completes and/or times-out).

At 409, method 400 may include the region back-end service 20 may create temporary blobs 53 in the region storage account 50 for newly received region requests 16 and access the temporary blobs 53 via SAS URLs. For example, data replication service 26 may create the temporary blobs 53 in the region storage account 50.

As such, method 400 may be used to establish a new region back-end service 20 to take over traffic from the global service 22 seamlessly without any down-time and/or disturbances to on-going customer requests for the cloud services 12.

Referring now to FIG. 4B, method 400 may continue by replicating the tables 37 between the global storages account 36 and the region storage account 50. Method 400 may wait for old requests, as described in step 408, to complete and/or time-out to ensure that the global back-end service 22 is not processing any pending request from Region 1.

At 410, method 400 may insert a head replica in the region RTable 40 as described in FIG. 3 above and may configure views of the region RTable 40 and the global RTable 30. For example, data replication service 26 may insert the head replica in the region RTable 40.

At 411, the global tables 37 of the global storage account 36 may be replicated using the region RTable 40, as discussed above at 405. For example, data replication service 26 may replicate the global tables 37 of the global storage account 36 using the region RTable 40.

At 412, any other tables 502 may be replicated in the region RTable 40 using a head replica. The head 42 of the region RTable 40 may be assigned to write only and the tail 44 of the region RTable 40 may be assigned read write and may read the other tables 502 from the global storage account 36. For example, the configuration of the region RTable 40 may include [Head^{WriteOnly}=Region Storage Account, Tail^{ReadWrite}=Global Storage Account]. Data replication service 26 may replicate any other tables 502 in the region RTable 40 using a head replica.

Rows in the global tables 37 and/or other tables accessed by region back-end service 20 are not accessed by the global back-end service 22 anymore since the region back-end service 20 is now receiving the Region 1 region requests 16 and not the global back-end service 22. However, RTable LINQ query will return such Rows to the global back-end service 22.

Only rows in the global tables 37 updated by region back-end service 20 may be replicated to the region storage account 50, and will have a new view ID 48 (FIG. 1). This means the Head replica may not have all needed data. To replicate data proactively, the Repair table method discussed in FIG. 3 may be used. However, all rows should not be replicated from the global storage account 36. Only the rows in the global tables 37 associated with Region 1 from the global storage account 36 may be replicated.

In an implementation, region RTable 40 may be configured with a Delegate Functions (Call-backs) on a per table basis. For a given table (e.g., global tables 37 and/or other tables 502), the Delegate Function returns whether a given row should be replicated to the region RTable 40. For example, data replication service 26 may include the Delegate Function.

An RTable repair protocol may be executed in region back-end service 20 to repair all tables. Data that belong to Region 1 will be replicated to the region storage account 50, and will have a new View ID 48. Now, the head replica has all Region 1 related data. As such, the same data will have the new View ID 48 in the Tail replica (e.g., the global storage account 36).

At this stage, a verification may occur to ensure the stability of the system. For example, data replication service 26 may perform the verification of the system. The system may be rolled-back to its original state (e.g., all the region requests 16 being handled by the global back-end service 22) if necessary for any reason. By removing the head replica from the region RTable 40 and bumping the View ID 48. In addition, by reconfiguring the global RTable 30 in the global back-end service 22 with the above View ID 48 and rerouting the Region 1 traffic back to the global back-end service.

Referring now to FIG. 4C, method 400 may continue by separating the region back-end service 20 from the global back-end service 22. At 413, method 400 may turn off the tail replica in region RTable 40 for the migrated tables 503. For example, data replication service 26 may turn off the tail replica in region RTable 40.

At 414, method 400 may keep the configuration for region RTable 40 for the global tables 37 as is. For example, data replication service 26 may keep the configuration for the global tables 37 as is for the region RTable 40.

By separating the region back-end service 20 from the global back-end service 22, region back-end service 20 may operate independently from the global back-end service 22. As such, if a data outage and/or natural disaster occurred in geographic regions outside of Region 1, customers in Region 1 may not be affected by the data outage and may continue to operate using the region back-end services 20 for the cloud services.

Other data regions may be identified and established for other geographic regions, thus, further minimizing the effect of the cloud services when a data outage occurs.

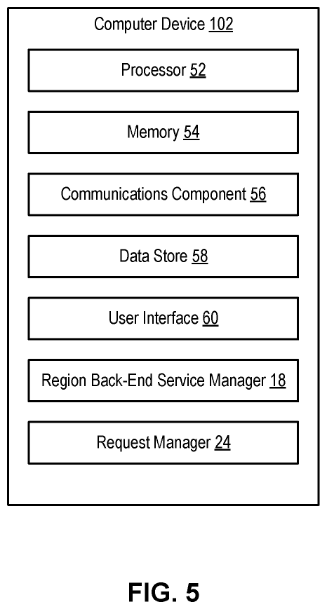

Referring now to FIG. 5, illustrated is an example computer device 102 in accordance with an implementation, including additional component details as compared to FIG. 1. In one example, computer device 102 may include processor 52 for carrying out processing functions associated with one or more of components and functions described herein. Processor 52 can include a single or multiple set of processors or multi-core processors. Moreover, processor 52 can be implemented as an integrated processing system and/or a distributed processing system.

Computer device 102 may further include memory 54, such as for storing local versions of applications being executed by processor 52. Memory 54 can include a type of memory usable by a computer, such as random access memory (RAM), read only memory (ROM), tapes, magnetic discs, optical discs, volatile memory, non-volatile memory, and any combination thereof. Additionally, processor 52 and memory 54 may include and execute operating system 110 (FIG. 1).

Further, computer device 102 may include a communications component 56 that provides for establishing and maintaining communications with one or more parties utilizing hardware, software, and services as described herein. Communications component 56 may carry communications between components on computer device 102, as well as between computer device 102 and external devices, such as devices located across a communications network and/or devices serially or locally connected to computer device 102. For example, communications component 56 may include one or more buses, and may further include transmit chain components and receive chain components associated with a transmitter and receiver, respectively, operable for interfacing with external devices.

Additionally, computer device 102 may include a data store 58, which can be any suitable combination of hardware and/or software, that provides for mass storage of information, databases, and programs employed in connection with implementations described herein. For example, data store 58 may be a data repository for region back-end service manager 18 (FIG. 1) and/or request manager 24 (FIG. 1).

Computer device 102 may also include a user interface component 60 operable to receive inputs from a user of computer device 102 and further operable to generate outputs for presentation to the user. User interface component 60 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 60 may include one or more output devices, including but not limited to a display, a speaker, a haptic feedback mechanism, a printer, any other mechanism capable of presenting an output to a user, or any combination thereof.

In an implementation, user interface component 60 may transmit and/or receive messages corresponding to the operation of region back-end service manager 18 and/or request manager 24. In addition, processor 52 executes region back-end service manager 18 and/or request manager 24, and memory 54 or data store 58 may store them.

As used in this application, the terms “component,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computer device and the computer device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various implementations or features may have been presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, and actions of methods described in connection with the embodiments disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computer devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or algorithm described in connection with the implementations disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some implementations, the processor and the storage medium may reside in an ASIC. Additionally, the ASIC may reside in a user terminal. In the alternative, the processor and the storage medium may reside as discrete components in a user terminal. Additionally, in some implementations, the steps and/or actions of a method or algorithm may reside as one or any combination or set of codes and/or instructions on a machine readable medium and/or computer readable medium, which may be incorporated into a computer program product.

In one or more implementations, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While implementations of the present disclosure have been described in connection with examples thereof, it will be understood by those skilled in the art that variations and modifications of the implementations described above may be made without departing from the scope hereof. Other implementations will be apparent to those skilled in the art from a consideration of the specification or from a practice in accordance with examples disclosed herein.

What is claimed is:

1. A computer device, comprising:
a memory to store data and instructions;
a processor in communication with the memory;
an operating system in communication with the memory and the processor, the operating system operable to:
initially process requests from a plurality of geographic regions for a cloud service using a global back-end service with a global storage account storing data from a plurality of geographic regions, wherein the global back-end service includes a global replicated table (“RTable”);
establish a region back-end service with a region storage account in at least one geographic region of the plurality of geographic regions to support the cloud service for users in the at least one geographic region, wherein the region back-end service includes a region RTable;
receive, by the region back-end service, user requests for the cloud service from one or more users in the at least one geographic region;
access, via the region RTable, one or more rows of data associated with the at least one geographic region from the global storage account in response to the user requests;
lock, by the global RTable, the one or more rows of data associated with the at least one geographic region in the global storage account during replication of the one or more rows of data in response to the access;
replicate the one or more rows of data accessed by the region RTable into the region storage account; and
update a configuration to inactivate the one or more rows of data associated with the at least one geographic region in the global storage account in response to a conclusion of the access to the one or more rows of data associated with the at least one geographic region by the region RTable in response to the user requests.

2. The computer device of claim 1, wherein the user requests times-out when the processing of the user requests exceeds a predetermined allotted time for the processing of user requests.

3. The computer device of claim 1, wherein to replicate subsets of the data associated with the at least one geographic region from the global storage account into the region storage account, the operating system is further configured to:
access, via the region RTable, the subsets of the data associated with the at least one geographic region from the global storage account not currently associated with any user request;
lock the one or more rows of the subsets of the data associated with the at least one geographic region in the global storage account during replication of the one or more rows of the subsets of data in response to the accessing;
replicate the one or more rows of the subsets of the data accessed by the region RTable from the global storage account into the region storage account; and
update the configuration to inactivate the one or more rows of the subsets of the data in the global storage account when the replication is complete.

4. The computer device of claim 3, wherein the operating system is further operable to replicate the subsets of the data associated with the geographic region while contemporaneously handling the user requests for the cloud service.

5. The computer device of claim 3, wherein to replicate the subsets of the data associated with the geographic region from the global storage account to the region storage account, the operating system is further configured to:
determine whether one or more rows of the subsets of the data in the global storage account are locked, and
wherein the operating system is configured to replicate in response to a determination that the one or more rows of the subsets of data are not locked.

6. The computer device of claim 5, wherein the operating system is further operable to:
prevent the one or more rows of the subsets of the data from replicating based upon the determination that the one or more rows of the subsets of the data are locked, and
wherein the operating system is configured to replicate at a later time in response to a determination that the one or more rows of the subset of the data are not locked.

7. The computer device of claim 3, wherein the operating system is further operable to:
modify the operation of the region RTable from a write only configuration to a read and write configuration upon completing replication of the subsets of data associated with the geographic region from the global storage account into the region storage account; and
separate the region back-end service from the global back-end service.

8. The computer device of claim 1, wherein the operating system is further operable to:
determine whether the data in the global storage account is associated with the geographic region by identifying whether the data is associated with one or more users in the geographic region.

9. The computer device of claim 1, wherein the operating system is further operable to transition the handling of the user requests from the global back-end service to the region back-end service by configuring one or more front end services associated with the cloud service to start sending the user requests to the region back-end service in response to the region RTable being setup in the region back-end service.

10. The computer device of claim 1, wherein the region back-end service takes over at least one user request that is partially completed by the global back-end service by temporarily accessing the global storage account until the at least one user request is completed or times out.

11. A method for data migration, comprising:
initially processing, by an operating system executing on a computer device, requests from a plurality of geographic regions for a cloud service using a global back-end service with a global storage account storing data from a plurality of geographic regions, wherein the global back-end service includes a global replicated table (“RTable”);
establishing a region back-end service with a region storage account in at least one geographic region of the plurality of geographic regions to support the cloud service for users in the at least one geographic region, wherein the region back-end service includes a region RTable;
receiving, by the region back-end service, user requests for the cloud service from one or more users in the at least one geographic region;
accessing, via the region RTable, one or more rows of data associated with the at least one geographic region from the global storage account in response to the user requests;
locking, by the global RTable, the one or more rows of data associated with the at least one geographic region in the global storage account during replication of the one or more rows of data in response to the access;
replicating the one or more rows of data accessed by the region RTable into the region storage account; and
updating a configuration to inactivate the one or more rows of data associated with the at least one geographic region in the global storage account in response to a conclusion of the access to the one or more rows of data associated with the at least one geographic region by the region RTable in response to the user requests.

12. The method of claim 11, wherein the user requests times-out when the processing of the user requests exceeds a predetermined allotted time for the processing of user requests.

13. The method of claim 11, wherein replicating the subsets of the data associated with the at least one geographic region from the global storage account into the region storage account further comprises:
accessing, via the region RTable, the subsets of the data associated with the at least one geographic region from the global storage account not currently associated with any user request;
locking the one or more rows of the subsets of the data associated with the at least one geographic region in the global storage account during replication of the one or more rows of the subsets of data in response to the accessing;
replicating the one or more rows of the subsets of the data accessed by the region RTable from the global storage account into the region storage account; and
updating the configuration to inactivate the one or more rows of the subsets of the data in the global storage account when the replication is complete.

14. The method of claim 13, wherein replicating the subsets of the data associated with the geographic region occurs while contemporaneously handling the user requests for the cloud service.

15. The method of claim 13, wherein replicating the subsets of the data associated with the geographic region from the global storage account to the region storage further comprises:
determining whether one or more rows of the subsets of the data in the global storage account are locked; and
replicating in response to a determination that the one or more rows of the subsets of data are not locked.

16. The method of claim 15, further comprising:
preventing the one or more rows of the subsets of the data from replicating in response to a determination that the one or more rows of the subsets of the data are locked; and
replicating at a later time in response to a determination that the one or more rows of the subset of the data are not locked.

17. The method of claim 13, wherein the method further comprises:
modifying the operation of the region RTable from a write only configuration to a read and write configuration upon completing replication of the subsets of data associated with the geographic region from the global storage account into the region storage account; and
separating the region back-end service from the global back-end service.

18. The method of claim 11, wherein the method further comprises:
determining whether the data in the global storage account is associated with the geographic region by identifying whether the data is associated with one or more users in the geographic region.

19. The method of claim 11, wherein the method further comprises:
transitioning the handling of the user requests from the global back-end service to the region back-end service by configuring one or more front end services associated with the cloud service to start sending the user requests to the region back-end service in response to the region RTable being setup in the region back-end service.

20. The method of claim 11, wherein the region back-end service takes over at least one user request that is partially completed by the global back-end service by temporarily accessing the global storage account until the at least one user request is completed or times out.

21. A computer-readable medium storing instructions executable by a computer device, comprising:
at least one instruction for causing the computer device to initially process requests from a plurality of geographic regions for a cloud service using a global back-end service with a global storage account storing data from a plurality of geographic regions, wherein the global back-end service includes a global replicated table (“RTable”);
at least one instruction for causing the computer device to establish a region back-end service with a region storage account in at least one geographic region of the plurality of geographic regions to support the cloud service for users in the at least one geographic region, wherein the region back-end service includes a region RTable;
at least one instruction for causing the computer device to receive, by the region back-end service, user requests for the cloud service from one or more users in the at least one geographic region;
at least one instruction for causing the computer device to access, via the region RTable, one or more rows of data associated with the at least one geographic region from the global storage account in response to the user requests;
at least one instruction for causing the computer device to lock, by the global RTable, the one or more rows of data associated with the at least one geographic region in the global storage account during replication of the one or more rows of data in response to the access;
at least one instruction for causing the computer device to replicate the one or more rows of data accessed by the region RTable into the region storage account; and
at least one instruction for causing the computer device to update a configuration to inactivate the one or more rows of data associated with the at least one geographic region in the global storage account in response to a conclusion of the access to the one or more rows of data associated with the at least one geographic region by the region RTable in response to the user requests.
